(19) United States
(12) Patent Application Publication
(10) Pub. No.: US 2019/0392619 A1
(43) Pub. Date: Dec. 26, 2019

(54) INFORMATION COMMUNICATION SYSTEM AND METHOD

(71) Applicant: Shizhi ZHOU, Guangdong (CN)

(72) Inventor: Shizhi ZHOU, Guangdong (CN)

(21) Appl. No.: 16/105,988

(22) Filed: Aug. 21, 2018

(30) Foreign Application Priority Data
Jun. 22, 2018 (CN) 201810654181.8

(51) Int. Cl. G06T 11/60; G06F 17/24; G06F 17/30; G06K 7/14; G06K 19/06; G06T 13/80

(52) U.S. Cl. CPC G06T 11/60; G06F 17/24; G06T 13/80; G06K 7/1417; G06K 19/06037; G06F 17/30312

(57) ABSTRACT

The present invention relates to the field of information communication, and in particular, to an information communication system and method. User terminals in the information communication system of the present invention communicate with each other through a virtual communication window created by a virtual communication module. During communication, users can communicate not only through text, voice, video and emoticons, but also through editing animations having scenarios in the virtual communication window, so that information is more intuitive and expressed more comprehensively. Moreover, an emoticon database real-time communicates with the virtual communication module, and thus emoticons can be real-time selected and used without downloading, which does not occupy local storage resources. In addition, emoticons of other systems can also be downloaded and saved in the emoticon database for use, so that expressions in the emoticon database are more diversified.

### BACKGROUND OF THE INVENTION

The present invention relates to the field of information communication, and in particular, to an information communication system and method.

In recent years, with continuous development of the Internet technology, messages are exchanged frequently via the network. Various information communication systems for chatting that can exchange messages in real time are also provided on social network services, and Internet-based social applications have been widely used. A user registers an account in a social application, which includes a contact list. The user can communicate with contacts in the list through the social application. When communicating with the contacts, the user often sends emoticons to the contacts to make the communication interesting.

However, chatting is often carried out by voice, text or video in existing information communication systems. Received information expressed only by voice is not comprehensive enough, information expressed only by text is not vivid enough, and information transmitted by video may be insufficient. Therefore, information needs to be expressed with the assistance of image expressions, but existing manners of acquiring image expressions all rely on emoticons stored locally. If no emoticons are stored locally, the user cannot send the image expressions, and the emoticons stored locally also occupy storage resources.

### BRIEF SUMMARY OF THE INVENTION

To solve the foregoing technical problem, the present invention provides an information communication system and method, which can edit scenario animations, has more intuitive information expression, further include an emoticon database that can be used without downloading emoticons, and do not occupy local storage resources.

To achieve the foregoing objective, the present invention adopts the following technical solution: an information communication system, including:

user terminals which are devices configured to log in to the information communication system and allow users to input and output information;

a virtual communication module configured to create a virtual communication window through which the user terminals communicate with each other in language, text, video and emoticons;

an emoticon database configured to store various static and dynamic emoticons and be communicatively connected with the virtual communication module in real-time; and

an action icon database configured to store program codes of editing actions of emoticons and be communicatively connected with the emoticon database and the virtual communication module in real-time, respectively;

wherein the virtual communication module includes an editing unit through which scenario animations are created in the virtual communication window.

Further, the information communication system further includes a link module through which a QR code or link displayed in the virtual communication window is communicatively connected with a third-party platform.

Further, the virtual communication module supports local downloading and editing of emoticons, voice, video and movies, and the emoticons downloaded locally by the virtual communication module are automatically saved to the emoticon database.

Further, the virtual communication module further includes a storage unit configured to store communication information in the virtual communication window.

The users can edit voice, text, pictures and video into scenario animations through the editing unit for communication on the basis of using emoticons for communication in the virtual communication window.

The users can edit voice, text, emoticons and pictures into scenario animations through the editing unit for communication on the basis of using video for communication in the virtual communication window.

The users can edit voice, text, emoticons and video into scenario animations through the editing unit for communication on the basis of using pictures for communication in the virtual communication window.

The users can edit voice, text, emoticons and pictures into scenario animations through the editing unit for communication on the basis of using animations for communication in the virtual communication window.

A communication method for the information communication system is further included, which includes the following steps:

S1. logging in to the information communication system through user terminals;

S2. a virtual communication module creating a virtual communication window;

S3. the user terminals communicating with each other in language, text, video and emoticons through the virtual communication window;

S4. users choosing to input, through an editing unit, keyword text in the virtual communication window to edit scenario animations for information communication; and

S5. a storage unit in the virtual communication module storing communication information in the virtual communication window locally.

The editing unit edits expressions in an emoticon database to make scenario animations through an action icon database.

Beneficial effects of the present invention are as follows: user terminals in the information communication system of the present invention communicate with each other through the virtual communication window created by the virtual communication module. During communication, users can communicate not only through text, voice, video and emoticons, but also through editing scenario animations edited in the virtual communication window, so that information is more intuitive and expressed more comprehensively. Moreover, the emoticon database real-time communicates with the virtual communication module, and thus emoticons can be selected in real-time and used without downloading, which does not occupy local storage resources. In addition, emoticons of other systems can also be downloaded and saved in the emoticon database for use, so that expressions in the emoticon database are more diversified.

### BRIEF DESCRIPTION OF THE DRAWINGS

FIG. 1 is a schematic structural diagram of an information communication system according to the present invention; and

FIG. 2 is a flow block diagram of a communication method for the information communication system according to the present invention.

Descriptions about reference numerals: 1. user terminal; 2. virtual communication module; 3. server; 31. emoticon database; 32. action icon database.

### DETAILED DESCRIPTION OF THE INVENTION

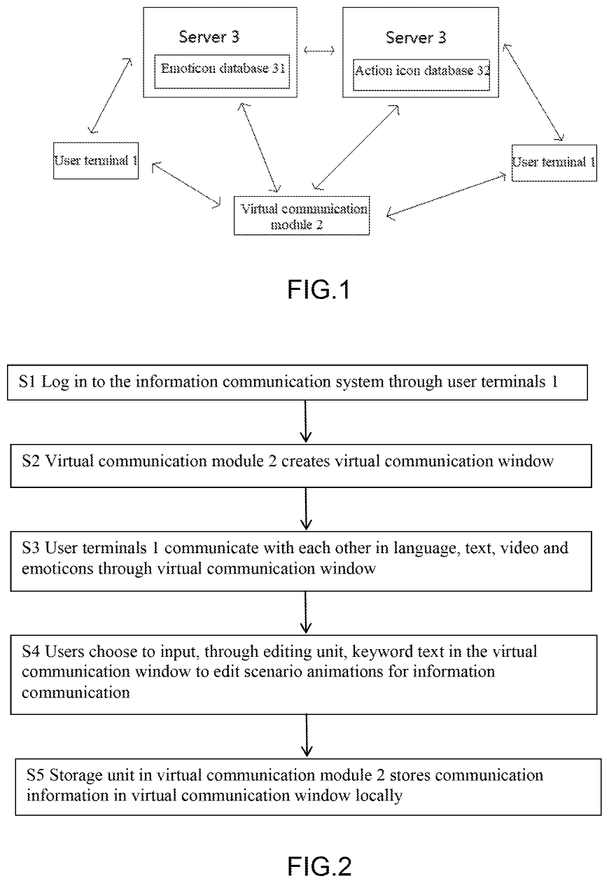

Referring to FIGS. 1-2, the present invention relates to an information communication system, including:

user terminals 1 which are devices configured to log in to the information communication system and allow users to input and output information;

a virtual communication module2 configured to create a virtual communication window through which the user terminals 1 communicate with each other in language, text, video and emoticons;

an emoticon database 31 configured to store various static and dynamic emoticons and be communicatively connected with the virtual communication module 2 in real-time; and

an action icon database 32 configured to store program codes of editing actions of emoticons and be communicatively connected with the emoticon database 31 and the virtual communication module 2 in real-time, respectively;

wherein the virtual communication module 2 includes an editing unit through which scenario animations are created in the virtual communication window.

Compared with the prior art, user terminals 1 in the information communication system of the present invention communicate with each other through a virtual communication window created by a virtual communication module 2. During communication, users can communicate not only through text, voice, video and emoticons, but also through editing scenario animations in the virtual communication window, so that information is more intuitive and expressed more comprehensively. Moreover, an emoticon database 31 real-time communicates with the virtual communication module 2, and thus emoticons can be selected in real-time and used without downloading, which does not occupy local storage resources. In addition, emoticons of other systems can also be downloaded and saved in the emoticon database 31 for use, so that expressions in the emoticon database 31 are more diversified.

The user terminals 1 are also communicatively connected with each other through an external server 3, and both the emoticon database 31 and the action icon database 32 are disposed in the server 3.

A link module is further included, through which a QR code or link displayed in the virtual communication window is communicatively connected with a third-party platform.

In this embodiment, users can be connected to other third-party platforms through QR codes or links, and which guide the users to perform operations such as reading, browsing or trading.

Further, the virtual communication module 2 supports local downloading and editing of emoticons, voice, video and movies, and the emoticons downloaded locally by the virtual communication module 2 are automatically saved to the emoticon database 31.

In this embodiment, the emoticon database 31 can save and update emoticons automatically, continuously accumulates emoticons for use by users, and share the emoticons with other user terminals 1.

Further, the virtual communication module 2 further includes a storage unit configured to store communication information in the virtual communication window.

In this embodiment, the virtual communication module 2 stores communication information of users through the storage unit, which facilitate the users to browse previous chatting records next time when they log in to the user terminals. A deletion module is further provided to allow the users to delete chatting records.

The users can edit voice, text, pictures and video into scenario animations through the editing unit for communication on the basis of using emoticons for communication in the virtual communication window.

The users can edit voice, text, emoticons and pictures into scenario animations through the editing unit for communication on the basis of using video for communication in the virtual communication window.

The users can edit voice, text, emoticons and video into scenario animations through the editing unit for communication on the basis of using pictures for communication in the virtual communication window.

The users can edit voice, text, emoticons and pictures into scenario animations through the editing unit for communication on the basis of using animations for communication in the virtual communication window.

In this embodiment, the users can edit, in the virtual communication window, voice, text, pictures, emoticons and video into scenario animations through the editing unit as required, and send the scenario animations to other user terminals 1, to express the users' thought.

In this embodiment, a communication method for the information communication system includes the following steps:

S1. logging in to the information communication system through user terminals 1;

S2. a virtual communication module 2 creating a virtual communication window;

S3. the user terminals 1 communicating with each other in language, text, video and emoticons through the virtual communication window;

S4. users choosing to input, through an editing unit, keyword text in the virtual communication window to edit scenario animations for information communication; and

S5. a storage unit in the virtual communication module 2 storing communication information in the virtual communication window locally.

The editing unit edits expressions in an emoticon database 31 to make scenario animations through an action icon database 32. As program codes of editing actions of emoticons are stored in the action icon database 32, the users can edit actions only by inputting key action terms and corresponding expression terms into the virtual communication module 2, and then edit, in combination with the editing of text, voice and pictures, communication information into scenario animations that the users want to express.

The above only describes the preferred embodiments of the present invention, but does not limit the scope of the present invention. Those skilled in the art can make various transformations and improvements to the technical solution of the present invention without departing from the design spirit of the present invention. These transformations and improvements should all fall within the protection scope determined by the claims of the present invention.

What is claimed is:

1. An information communication system, comprising:
user terminals which are devices configured to log in to the information communication system and allow users to input and output information;
a virtual communication module configured to create a virtual communication window through which the user terminals communicate with each other in language, text, video and emoticons;
an emoticon database configured to store various static and dynamic emoticons and be communicatively connected with the virtual communication module in real-time; and
an action icon database configured to store program codes of editing actions of emoticons and be communicatively connected with the emoticon database and the virtual communication module in real-time, respectively;
wherein the virtual communication module comprises an editing unit through which scenario animations are created in the virtual communication window.

2. The information communication system according to claim 1, further comprising a link module through which a QR code or link displayed in the virtual communication window is communicatively connected with a third-party platform.

3. The information communication system according to claim 1, wherein the virtual communication module supports local downloading and editing of emoticons, voice, video and movies, and the emoticons downloaded locally by the virtual communication module are automatically saved to the emoticon database.

4. The information communication system according to claim 1, wherein the virtual communication module further comprises a storage unit configured to store communication information in the virtual communication window.

5. The information communication system according to claim 1, wherein the users can edit voice, text, pictures and video into scenario animations through the editing unit for communication on the basis of using emoticons for communication in the virtual communication window.

6. The information communication system according to claim 1, wherein the users can edit voice, text, emoticons and pictures into scenario animations through the editing unit for communication on the basis of using video for communication in the virtual communication window.

7. The information communication system according to claim 1, wherein the users can edit voice, text, emoticons and video into scenario animations through the editing unit for communication on the basis of using pictures for communication in the virtual communication window.

8. The information communication system according to claim 1, wherein the users can edit voice, text, emoticons and pictures into scenario animations through the editing unit for communication on the basis of using animations for communication in the virtual communication window.

9. A communication method for the information communication system according to claim 1, comprising the following steps:
S1. logging in to the information communication system through user terminals;
S2. a virtual communication module creating a virtual communication window;
S3. the user terminals communicating with each other in language, text, video and emoticons through the virtual communication window;
S4. users choosing to input, through an editing unit, keyword text in the virtual communication window to edit scenario animations for information communication; and
S5. a storage unit in the virtual communication module storing communication information in the virtual communication window locally.

10. The communication method for the information communication system according to claim 9, wherein the editing unit edits expressions in an emoticon database to make scenario animations through an action icon database.
